(19) United States
(12) Patent Application Publication
(10) Pub. No.: US 2026/0025686 A1
(43) Pub. Date: Jan. 22, 2026

(54) ADAPTIVE RADIO DATA COLLECTION AND REPORTING

(71) Applicant: Dell Products L.P., Round Rock, TX (US)

(72) Inventor: Ali Esswie, Calgary (CA)

(21) Appl. No.: 18/777,199

(22) Filed: Jul. 18, 2024

(51) Int. Cl. H04W 24/10; H04W 24/08

(52) U.S. Cl. CPC H04W 24/10; H04W 24/08

(57) ABSTRACT

A user equipment receives from a radio network node parameter reporting configuration information indicative of radio parameters and radio parameter quantization categories. During a configured quantization validity period the user equipment categorizes measured radio parameter values corresponding to configured radio parameters into quantization categories corresponding to the parameters according to parameter value ranges respectively associated with the categories with respect to which ranges the measured values fall into, or match. If, during the validity period, a number, or count, of parameter values that have been categorized into a particular category and reported to the node exceeds a reporting criterion, the user equipment may modify a parameter value reporting periodicity or avoid reporting measured parameter values corresponding to the particular category during the remainder of the validity period, after the expiration of which the user equipment may reset the count for the particular category.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose, on a given RAN resource, loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise determining, by at least one user equipment comprising at least one processor with respect to a radio network node, at least one parameter value corresponding to at least one parameter to result in at least one determined parameter value and analyzing, by the at least one user equipment, the at least one determined parameter value with respect to at least one quantization category range criterion corresponding to at least one quantization category. Based on the at least one determined parameter value being determined to satisfy the at least one quantization category range criterion, the method may further comprise assigning, by the at least one user equipment, the at least one determined parameter value to at least one quantization category associated with the at least one quantization category range criterion to result in at least one assigned quantization category. The method may further comprise determining, by the at least one user equipment, a number of the at least one determined parameter value assigned to the at least one assigned quantization category to result in at least one assigned quantization category count and analyzing, by the at least one user equipment, at least the at least one assigned quantization category count with respect to at least one assigned quantization category reporting criterion associated with the at least one assigned quantization category to result in at least one analyzed assigned quantization category count. Based on the at least one analyzed assigned quantization category count being determined to satisfy the at least one assigned quantization category reporting criterion, the method may further comprise performing, by the at least one user equipment, at least one reporting operation with respect to the at least one determined parameter value.

In an example embodiment, the method may further comprise determining, by the at least one user equipment, that a configured quantization period has expired. In response to the determining that the configured quantization period has expired, the method may further comprise resetting, by the at least one user equipment, the at least one assigned quantization category count.

In an example embodiment, the at least one assigned quantization category reporting criterion may comprise at least one report halting criterion. The at least one assigned quantization category reporting criterion may be determined to be satisfied by the at least one assigned quantization category count being determined to satisfy a function with respect to a threshold count defined by the at least one report halting criterion. The at least one reporting operation may comprise avoiding reporting, or halting reporting during a remainder of a validity period corresponding to the at least one quantization category, the at least one determined parameter value to the radio network node.

In an example embodiment, the at least one determined parameter value may be at least one first determined parameter value. The method may further comprise determining, by the at least one user equipment, at least one second parameter value corresponding to the at least one parameter to result in at least one second determined parameter value and analyzing, by the at least one user equipment, the at least one second determined parameter value with respect to the at least one quantization category range criterion. Based on the at least one second determined parameter value being determined to satisfy the at least one quantization category range criterion, the method may further comprise assigning, by the at least one user equipment, the at least one second determined parameter value to the at least one assigned quantization category. Based on expiration of at least one assignment quantization category validity period corresponding to the at least one assigned quantization category, the method may comprise reporting, by the at least one user equipment, at least the at least one second determined parameter value to the radio network node.

In an example embodiment, the at least one parameter may comprise at least one of: a received signal signal strength corresponding to a signal corresponding to the radio network node or a received signal signal strength to interference ratio corresponding to the signal corresponding to the radio network node.

In an example embodiment, the at least one parameter value may be a first parameter value. The at least one determined parameter value may be a first determined parameter value. The at least one quantization category may be a first quantization category. The number of the at least one determined parameter value assigned to the at least one assigned quantization category may be a first number. The at least one quantization category range criterion may be at least one first quantization category range criterion. The at least one assigned quantization category may be at least one first assigned quantization category. The at least one assigned quantization category count may be at least one first assigned quantization category count. The at least one analyzed assigned quantization category count may be at least one first analyzed assigned quantization category count. The at least one reporting operation may be at least one first reporting operation. The at least one assigned quantization category reporting criterion may be at least one first assigned quantization category reporting criterion. The method may further comprise determining, by the at least one user equipment, at least one second parameter value corresponding to the at least one parameter to result in at least one second determined parameter value and analyzing, by the at least one user equipment, the at least one second determined parameter value with respect to a second quantization category range criterion corresponding to a second quantization category associated with the at least one parameter. Based on the at least one second determined parameter value being determined to satisfy the second quantization category range criterion, the method may further comprise assigning, by the at least one user equipment, the at least one second determined parameter value to the second quantization category to result in a second assigned quantization category. The method may further comprise determining, by the at least one user equipment, a second number of the at least one second determined parameter value assigned to the second quantization category to result in a second assigned quantization category count and analyzing, by the at least one user equipment, the second assigned quantization category count with respect to a second assigned quantization category reporting criterion associated with the second quantization category to result in a second analyzed assigned quantization category count. Based on the second analyzed assigned quantization category count being determined to fail to satisfy the second assigned quantization category reporting criterion, the method may further comprise performing, by the at least one user equipment, a second reporting operation with respect to the at least one second determined parameter value.

In an embodiment, the second analyzed assigned quantization category count being determined to fail to satisfy the second assigned quantization category reporting criterion may comprise the second analyzed assigned quantization category count being determined to be equal to or to be less than the second assigned quantization category reporting criterion. The second reporting operation may comprise reporting, by the at least one user equipment to the radio network node, the at least one second determined parameter value.

In an example embodiment, the at least one parameter may be at least one first parameter. The at least one parameter value may be at least one first parameter value. The at least one determined parameter value may be at least one first determined parameter value. The at least one quantization category may be at least one first quantization category. The number of the at least one determined parameter value assigned to the at least one assigned quantization category may be a first number. The at least one quantization category range criterion may be at least one first quantization category range criterion. The at least one assigned quantization category may be at least one first assigned quantization category. The at least one assigned quantization category count may be at least one first assigned quantization category count. The at least one analyzed assigned quantization category count may be at least one first analyzed assigned quantization category count. The at least one reporting operation may be at least one first reporting operation. The at least one first reporting operation may comprise avoiding, by the at least one user equipment, reporting the at least one first determined parameter value to the radio network node. The at least one assigned quantization category reporting criterion may be at least one first assigned quantization category reporting criterion. The method may further comprise determining, by the at least one user equipment, at least one second parameter value corresponding to at least one second parameter to result in at least one second determined parameter value, wherein the at least one first parameter and the at least one second parameter are different and analyzing, by the at least one user equipment, the at least one second determined parameter value with respect to a second quantization category range criterion corresponding to at least one second quantization category associated with the second parameter. Based on the at least one second determined parameter value being determined to satisfy the at least one second quantization category range criterion, the method may further comprise assigning, by the at least one user equipment, the at least one second determined parameter value to the at least one second quantization category to result in at least one second assigned quantization category. The method may further comprise determining, by the at least one user equipment, a second number of the at least one second determined parameter value assigned to the at least one second quantization category to result in at least one second assigned quantization category count and analyzing, by the at least one user equipment, the at least one second assigned quantization category count with respect to at least one second assigned quantization category reporting criterion associated with the at least one second quantization category to result in at least one second analyzed assigned quantization category count. Based on the at least one second analyzed assigned quantization category count being determined to fail to satisfy the at least one second assigned quantization category reporting criterion, the method may further comprise performing, by the at least one user equipment, at least one second reporting operation with respect to the at least one second determined parameter value.

In an example embodiment, the at least one second analyzed assigned quantization category count being determined to fail to satisfy the at least one second assigned quantization category reporting criterion may comprise the at least one second analyzed assigned quantization category count being determined to satisfy a function of a count defined by the at least one second assigned quantization category reporting criterion. The second reporting operation may comprise reporting, by the at least one user equipment to the radio network node, the at least one second determined parameter value.

In an example embodiment, the method may further comprise receiving, by the at least one user equipment from the radio network node, parameter reporting configuration information comprising at least the at least one quantization category range criterion.

In another example embodiment, a user equipment may comprise at least one processor configured to process executable instructions that, when executed by the at least one processor, may facilitate performance of operations that may comprise determining at least one parameter value corresponding to at least one parameter to result in at least one determined parameter value and analyzing the at least one determined parameter value with respect to at least one quantization category range criterion. Based on the at least one determined parameter value being determined to satisfy the at least one quantization category range criterion, the operations may further comprise categorizing the at least one determined parameter value into at least one quantization category associated with the at least one quantization category range criterion to result in at least one categorized determined parameter value. The operations may further comprise determining a count of the at least one categorized determined parameter value to result in at least one quantization category count and analyzing the at least one quantization category count with respect to at least one quantization category reporting criterion associated with the at least one quantization category to result in at least one quantization category count. Based on the at least one quantization category count being determined to satisfy the at least one quantization category reporting criterion, the operations may further comprise performing at least one reporting operation with respect to the at least one determined parameter value.

In an example embodiment, the at least one quantization category reporting criterion comprises at least one report halting criterion. The at least one quantization category reporting criterion may be determined to be satisfied by the at least one quantization category count being determined to equal or to exceed a value defined in accordance with the at least one report halting criterion. The at least one reporting operation may comprise avoiding reporting the at least one determined parameter value to a radio network node.

In yet another example embodiment, a non-transitory machine-readable medium may comprise executable instructions that, when executed by at least one processor of a user equipment, may facilitate performance of operations that may comprise receiving, from radio network equipment, parameter reporting configuration information comprising at least one radio parameter indication indicative of at least one radio parameter, at least one quantization category range criterion corresponding to the at least one radio parameter, and at least one quantization category reporting criterion associated with the at least one quantization category range criterion. The operations may further comprise measuring the at least one radio parameter to result in at least one measured radio parameter value. The operations may further comprise categorizing the at least one measured radio parameter value into at least one quantization category associated with the at least one quantization category range criterion to result in at least one categorized measured radio parameter value, counting the at least one categorized measured radio parameter value to result in at least one quantization category count value, and analyzing the at least one quantization category count value with respect to the at least one quantization category reporting criterion to result in at least one analyzed quantization category count value. Based on the at least one analyzed quantization category count value, the operations may further comprise performing at least one reporting operation with respect to the at least one measured radio parameter value.

In an example embodiment, the at least one quantization category reporting criterion may comprise at least one report halting criterion. The at least one quantization category reporting criterion may be determined to be satisfied by the at least one analyzed quantization category count value being determined to equal or to exceed a value defined in accordance with the at least one report halting criterion. The at least one reporting operation may comprise avoiding reporting the at least one measured radio parameter value to the radio network equipment. The at least one reporting operation may comprise modifying a reporting periodicity to result in delaying at least one reporting instant at which the at least one measured radio parameter value is reported to the radio network equipment.

In an example embodiment, the at least one quantization category reporting criterion may comprise at least one report halting criterion. The at least one analyzed quantization category count value may be determined to fail to satisfy the at least one quantization category reporting criterion based on the at least one analyzed quantization category count value being determined to equal or to be less than a value defined in accordance with the at least one report halting criterion. The at least one reporting operation may comprise reporting the at least one measured radio parameter value to the radio network equipment.

In an example embodiment, the parameter reporting configuration information may further comprise at least one quantization period indication indicative of at least one quantization period. The at least one measured radio parameter value may further result from measuring the at least one radio parameter during the at least one quantization period. The operations may further comprise resetting the at least one quantization category count value after the at least one quantization period.

### BRIEF DESCRIPTION OF THE DRAWINGS

FIG. 1 illustrates wireless communication system environment.

FIG. 2 illustrates an example environment with a user equipment measuring a signal corresponding to a radio network node and determining whether to report to the node measured parameter values corresponding to the signal.

FIG. 3 illustrates example parameter reporting configuration information.

FIG. 4 illustrates example quantization categories corresponding to a radio parameter.

FIG. 5 illustrates an example measured radio parameter values report information.

FIG. 6 illustrates an example timing diagram of an example embodiment of a user equipment determining whether to report measured radio parameter values that have been assigned to a quantization category.

FIG. 7 illustrates a flow diagram of an example embodiment method of categorizing measured radio parameter values into quantization categories and determining whether to report the values quantized into a particular category based on how many parameter values have been quantized into the particular category during a quantization period.

FIG. 8 illustrates a block diagram of an example method embodiment.

FIG. 9 illustrates a block diagram of an example user equipment embodiment.

FIG. 10 illustrates a block diagram of an example non-transitory machine-readable medium embodiment.

FIG. 11 illustrates an example computer environment.

FIG. 12 illustrates a block diagram of an example wireless user equipment.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence and machine learning (“AI/ML”) may facilitate optimizing performance as compared to rules-based techniques in myriad fields. With respect to 5G NR, and future wireless communication generations, AI/ML may facilitate operations including, for example, channel state information acquisition/prediction, radio positioning, and beam management. An AI/ML model may be trained at one entity, for example at a gNB/RAN node or at a user equipment. A trained model trained at one entity may be transferred to the other via radio interface link(s). For example, a learning model may be trained at a RAN node and transferred, ready for execution, to various AI-capable user equipment or user devices. Thus, AI/ML processing-heavy model training may be separated from the entity actively running such model to facilitate radio functionality.

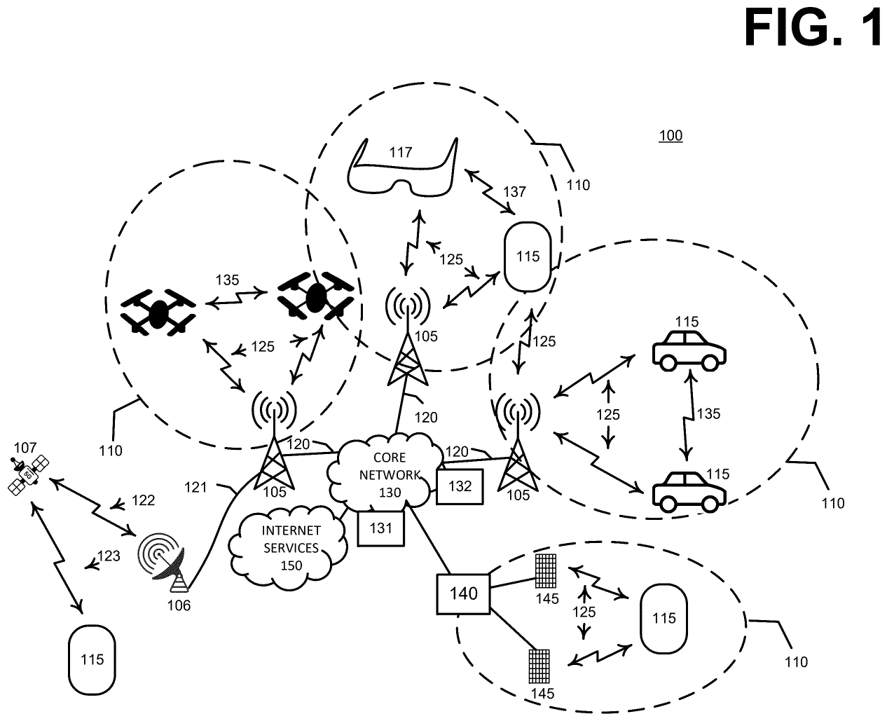

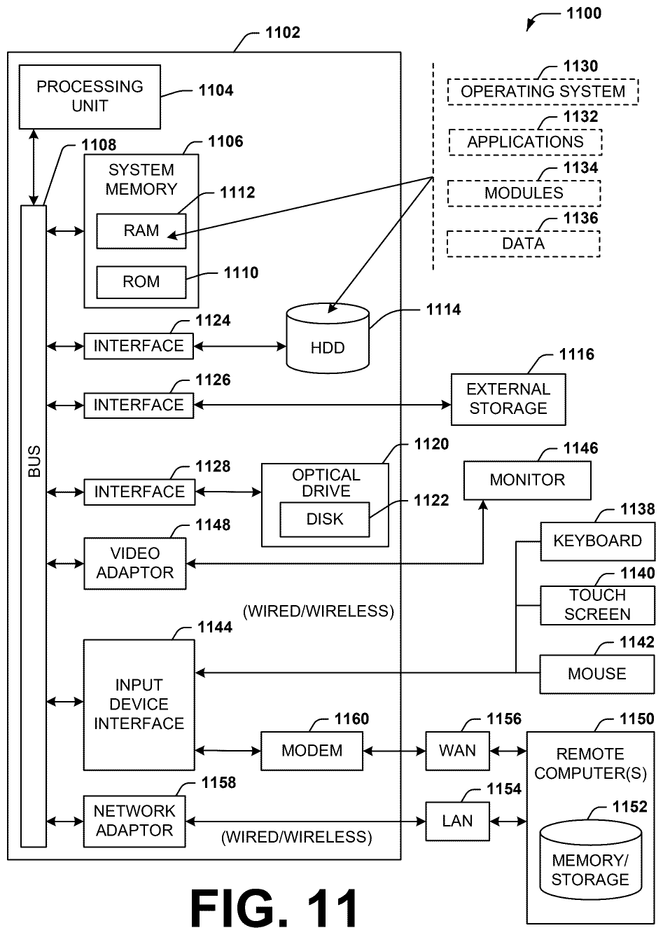

Turning now to the figures, FIG. 1 illustrates an example of a wireless communication system 100. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, may transmit or receive wireless signals with a RAN base station 105 via a long-range wireless link 125, or the UE may receive or transmit wireless signals via a short-range wireless link 137, which may comprise a wireless link with another UE device 115, such as a Bluetooth link, a Wi-Fi link, and the like. A RAN 105, or a component thereof, may be implemented by one or more computer components that may be described in reference to FIG. 25. A UE may comprise components described in reference to FIG. 11

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling, or control signaling, that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHZ)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of

UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Data collection and/or model retraining may facilitate deploying and maintaining efficient real-time artificial intelligence (“AI”) learning models in a wireless communication radio network comprising a RAN node and at least one user equipment if radio conditions surrounding the user equipment change. Collecting sufficiently long and diverse data samples that reflect various information corresponding to radio channel conditions is desirable to facilitate real-time adjusting of an AI learning model to match changed radio conditions. However, for on-device AI models, such data collection operation may be conducted via valuable and capacity-limited cellular (e.g., 5G) radio interface. For example, retraining or updating of an AI model that may be used at a user equipment and that may facilitate channel estimation may be derived by a third-party server or network edge entity may need continuous diverse data samples transmitted by user equipment or user devices for the model to be sufficiently retrained and refined before an updated version of the model is delivered to the user equipment. Because AI data collection tends to consume, or comprise, a large amount of data per user equipment or user device, and because such data samples may be delivered as data channel data or control channel information, transmitting, by a user equipment to a serving RAN node, measured parameter data values to be used to update a learning model at the radio network node may lead to a problem of significant consumption of uplink radio resources. Thus, it is desirable to compress and optimize the size or amount of radio parameter information, transmitted by a user equipment, that may be used to train, update, or adjust a learning model without negatively affecting the quality or effective usable information used to train the model.

To solve problems of uplink resource consumption related to transmitting of measured parameter values that may be used to train a learning model at a serving RAN node, AI data/radio parameter collection and reporting procedures disclosed herein may be implemented by user equipment to adaptively trigger AI data signaling/feedback/reporting of measured parameter data value only when a data sample to be fed-back (e.g., reported to the RAN node) is likely to provide new/diverse mutual information with respect to parameter data values that may have been previously fed-back/signaled/reported by the user equipment to a serving RAN during a pre-configured time period, which may be referred to herein as a quantization period, quantization validity period, or simply a validity period, thus minimizing wasting of uplink resource capacity to transmit non-useful radio parameter data samples. According to embodiments disclosed herein, a determination may be made that some measured radio parameter data samples, or values, are not useful for training an AI model and thus only radio parameter data values that represent a diverse or unique characteristic as compared to previously reported parameters may be reported back to the serving RAN. For example, a user equipment or a user device experiencing good radio conditions (e.g., radio channel conditions that may result from the user equipment being geographically close to the serving RAN node and thus signal strength corresponding to the RAN node at the user equipment is high), may always measure radio parameter values that are indicative of, or that correspond to, ‘good’ radio conditions and thus repeated reporting by the user equipment to the serving RAN of radio parameter values indicative of good coverage would not provide new/distinctive information with respect to information already reported by the user equipment to the serving RAN node. Instead, according to example embodiments disclosed herein, at least one radio parameter may be defined in configuration information that may be transmitted from a serving RAN to user equipment and at least one quantization category, corresponding to each of the at least one radio parameter, may be indicated by the configuration information. A user equipment with on-device AI capability may monitor the at least one radio parameter and may measure or calculate parameter values corresponding thereto and the user equipment may determine to which quantization category to assign a measured or determined parameter value based on the measured or determined parameter value being analyzed with respect to ranges corresponding to the at least one quantization category. Accordingly, a user equipment may trigger reporting, to a serving RAN node, of measured radio parameter values corresponding to a parameter and categorized into a particular quantization category only if a volume, number, or count of previously reported parameter values corresponding to the particular quantization category do not equal or exceed a configured reporting criterion during a configured quantization validity period corresponding to the particular quantization category. Such data volume restriction facilitates limiting user equipment from unnecessarily triggering reporting of too many radio parameter values to be used for AI learning model retraining and thus may facilitate avoiding overwhelming uplink data channel and/or uplink control channel capacity with reporting of non-useful (e.g., redundant) AI data sample parameter values. After a validity period corresponding to a particular quantization category expires, the user equipment may reset (e.g., set a count value to zero) a count corresponding to the particular quantization category to avoid the user equipment not sending any measured parameter values, corresponding to the particular quantization category, to the serving RAN node such that long-term lack of measured parameter values corresponding to the quantization category being transmitted to the serving RAN node may be minimized or avoided.

Embodiments disclosed herein may facilitate a user equipment reporting to a RAN node measured parameter values corresponding to a particular quantization category if previous reports from the user equipment to the serving RAN node corresponding to the particular quantization category do not exceed a configured size, volume, or count, regardless of the actual measured parameter value.

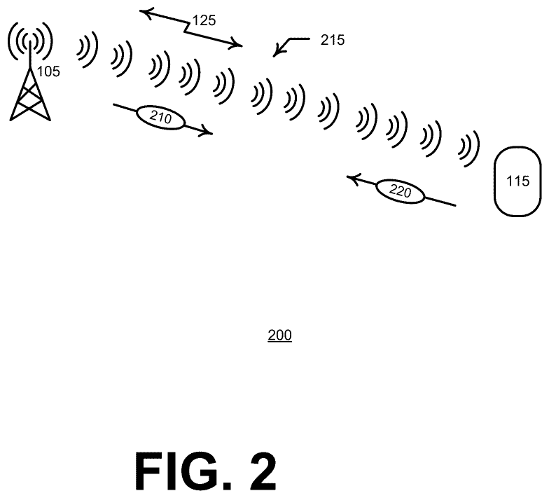

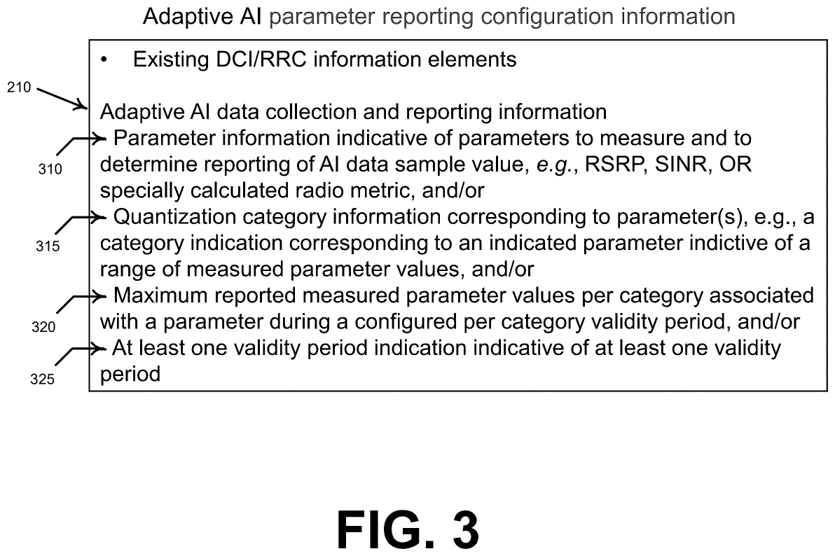

Turning now to FIG. 2, environment 200 may comprise a radio network node 105 and user equipment 115. User equipment 115 may represent more than one user equipment. One user equipment is illustrated for purposes of clarity and simplicity. RAN node 105 may transmit, to user equipment 115 via a downlink radio interface link 125, parameter reporting configuration information 210. Information 210 may be referred to as artificial intelligence data collection/training adaptive reporting configuration information. User equipment 115 may receive parameter reporting configuration information 210, which may comprise, in field 315 shown in FIG. 3, at least one quantization category range criterion corresponding to at least one quantization category. Information 210 may comprise parameter information indicative of at least on parameter, for example, a signal strength or signal to interference ratio, corresponding to a signal 215 transmitted, or broadcast, by RAN node 105. User equipment 115 may measure parameter values with respect to the at least one parameter, indicated in field 310 shown in FIG. 3, that correspond to signal 215. Measured parameter values may be usable by user equipment 115 to determine whether to report measured parameter values to RAN node 105. Quantization information indicated in field 315 may be indicative of categories, or ‘buckets’, into which user equipment 115 may categorize, or assign, measured parameter values. The categories may be indicated as corresponding to parameters indicated in field 310. For example, for a parameter specified in field 310, field 315 may indicate a first category and a corresponding first parameter value range, a second category and a corresponding second parameter value range, a third category and a corresponding third parameter value range, and so on. In field 320, information 210 may indicate a reporting criterion value to be applicable by user equipment 115 to a number of measured parameter values that the user equipment has assigned to, or categorized into, a particular quantization category indicated in field 315 during a quantization validity period indicated in field 325 that corresponds to the particular quantization category. In an embodiment, the reporting criterion value may be applicable to a number of measured parameter values that user equipment 115 has assigned to, or categorized into, a particular quantization category and has reported to RAN node 105 during quantization validity period that corresponds to the category. The reporting criterion value indicated by field 320 may be, or may comprise, a halting criterion such that satisfaction of the halting criterion may result in the user equipment suspending, pausing, delaying, or otherwise halting, during a remaining portion of the validity period that corresponds to the particular category, reporting to RAN node 105 measured parameter values that have been categorized by the user equipment into the particular category.

Thus, in an example embodiment, if user equipment 115 determines that a count, or number, of measured parameter values categorized into a particular quantization category and reported to RAN node 105 during a corresponding validity period exceeds a reporting criterion indicated in field 320, the user equipment may determine to avoid further reporting of measured parameter values, corresponding to a parameter associated with the particular quantization category, that have been assigned to, or categorized into, the particular quantization category until the validity period expires, after which the user equipment may flush, or reset, the a count value corresponding to the particular quantization category. Accordingly, configuration information 210 may facilitate dynamic AI data sample reporting behavior by user equipment 115 such that reporting of measured parameter values corresponding to a particular quantization category are not more frequent or more voluminous than an AI learning model being updated by RAN node 105 can practicably use for accurate and efficient training or updating. Thus, user equipment 115 may avoid consuming uplink radio link resources to transmit to RAN node 105 radio parameter measurement reports comprising measured radio parameter values corresponding to measurements performed with respect to signal 215 if such measured radio parameter values would not only not increase a confidence level of an AI learning model being updated by the RAN node 105 but if such measured parameter values may actually erroneously bias the learning model with more than a configured number of parameter values (e.g., configured via field 320) that are similar because the measured parameter values have been categorized, based on category ranges indicated in field 315, into a particular quantization category indicated by field 315.

User equipment 115 may measure, determine, or calculate a parameter value corresponding to a parameter configured via field 310. A parameter configured via field 310 may relate to information usable to determine radio or device performance indicators. For example, parameters configured via field 310 may comprise signal-to-interference-noise-ratio (“SINR”), reference-signal-receive-power (“RSRP”), reference signal received quality (“RSRQ”), received signal strength indication (RSSI″), Reference Signal Interference Power (“RSIP”), channel quality indicator (“CQI”), channel estimation mean error, other parameters, or combinations thereof. User equipment 115 may determine a quantization category to which, or into which, a measured or determined parameter value is assigned, or categorized, based on the measured or determined parameter value satisfying a criterion, for example a range, associated in information 210 with the category and corresponding in information 210 with the parameter with respect to which the parameter value is measured or determined.

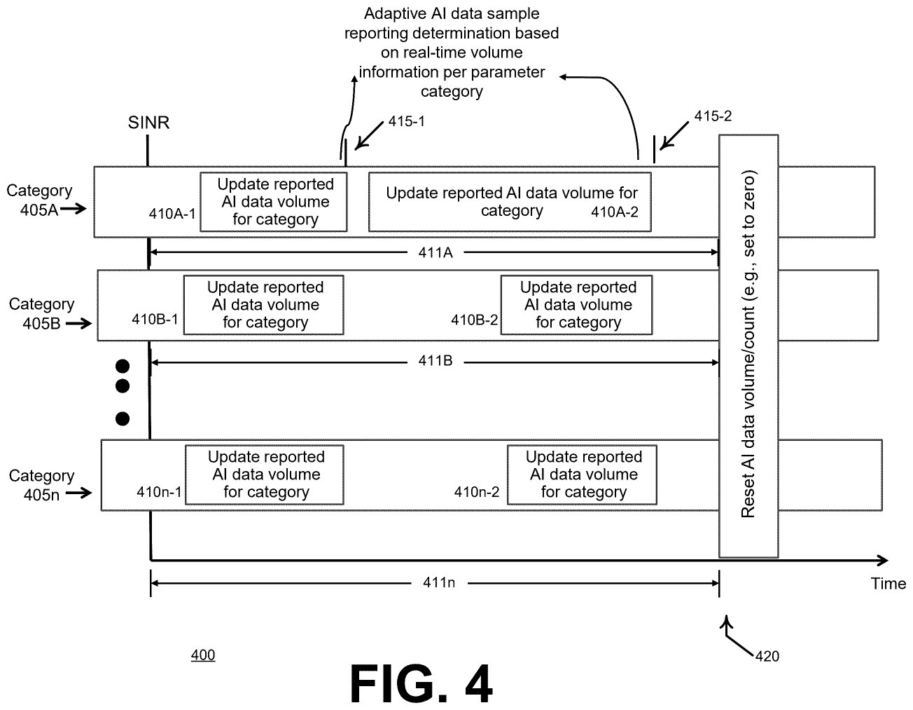

FIG. 4 illustrates quantization categories 405A, 405B, . . . 405n corresponding to a parameter SINR. (SINR is used as an illustrative example, but the description relative to FIG. 4 is applicable to other parameters.) During validity periods 411A, 411B, and 41 In respectively corresponding to quantization categories 405A, 405B, and 405n, a user equipment may determine numbers, counts, or volumes 410A−1, 410B−1, and 410n−1 of previously reported SINR values categorized, respectively, into quantization categories 405A, 405B, and 405n. Validity periods 411A, 411B, and 41 In may be the same or may be different with respect to each of quantization categories 405. The user equipment may analyze the quantization category count values 410A−1, 410B−1, and 410n−1 with respect to quantization category reporting criteria, indicated in field 320, associated with the categories to minimize starving an AI learning model at a radio network node of data sample but to also minimize reporting of redundant parameter values that may erroneously bias, or skew, training or updating of the learning mode. For example, as shown in FIG. 4, at reporting instant 415-1, which may be a configured reporting instant or which may be determined by the user equipment, measured parameter value counts 410A−1, 410B−1, and 410n−1 of measured parameter values respectively categorized into quantization categories 405A, 405B, and 405n, may all comprise counts of parameter values that have been measured by the user equipment or reported to a RAN node by the user equipment that do not equal or exceed a reporting criterion configured via field 320 shown in FIG. 3. Accordingly, in an example embodiment, at reporting instant 415-1, a user equipment may report to a RAN node serving the user equipment the measured parameter values that have been categorized into quantization categories 405A, 405B, and 405n. In another example embodiment, at reporting instant 415-1, the user equipment may report to the serving RAN node counts 410A−1, 410B−1, and 410n−1 of measured parameter values that have been categorized into quantization categories 405A, 405B, and 405n. However, at reporting instant 415-2, as shown in FIG. 4, count 410A−2, which may comprise a number of measured or determined parameter values that have been categorized into category 405A and reported to the serving RAN node, is larger than counts 410B−2 and 410n−2. It will be appreciated that reporting instances 415-1 and 415-2 are shown for purposes of description and that at least one reporting instance may have occurred therebetween. If a reporting/halting criterion indicated in field 320 that corresponds to SINR indicated in field 310 is equal to or greater than two times count 410A−1 (for purposes of example, counts 410A−1, 410B−1, 410n−1, 410B−2, and 410n−2 are shown as being equal), but is less than or equal to count 410A−1 plus 410A−2, the reporting/halting criterion may be deemed to be satisfied and the user equipment may avoid reporting, to the serving RAN node at reporting instance 415-2, parameter values (or counts 410 thereof) corresponding to quantization category 405A, but may report parameter values, or counts thereof, corresponding to categories 405B and 405n. Put another way, when, for example, a sum of a number of parameter values corresponding to SINR quantization category 405A that has/have been categorized into the category and indicated to a serving RAN node during validity period 411A equals or exceeds a count criterion corresponding to the quantization category, the user equipment may determine to avoid reporting, during the remainder of validity period 411A, SINR values, measured or determined with respect to signal 215, that fall within, or that satisfy, a quantization category range criterion associated in field 315 with quantization category 405A. However, in another example, when a sum of a number of parameter values corresponding to a quantization category that has/have been indicated to a serving RAN node during a validity period is less than a count criterion corresponding to a parameter or a quantization category, the user equipment may determine to continue reporting, during the remainder of a corresponding validity period, measured or determined parameter values categorized into a particular quantization category. After expiration 420 of a validity period 411, the user equipment may flush, or reset, count values 410 corresponding to the validity period and may begin reporting measured parameter values categorized into quantization categories until a count of a particular quantization category again equals or exceeds a reporting criterion configured via field 320 shown in FIG. 3.

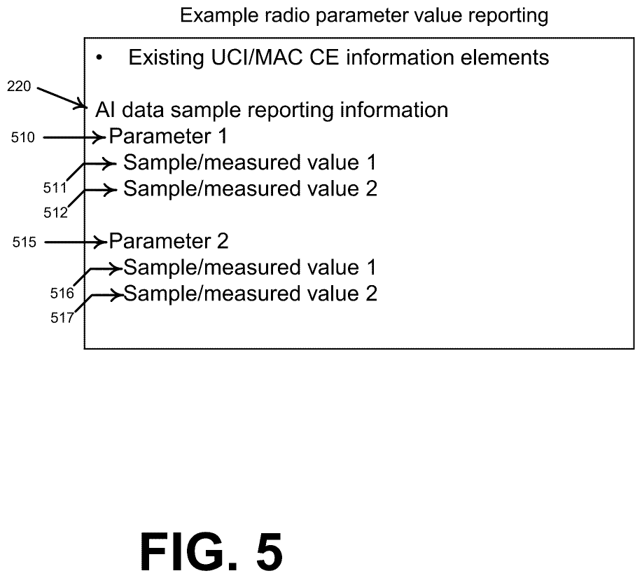

FIG. 5 illustrates example measured parameter value report information 220 shown in FIG. 2. In reference to FIG. 4, based on a parameter value volume or count 410 corresponding to a category 405 being determined to be equal to or less than a configured maximum allowed reporting count criterion configured via field 320 and corresponding to a particular parameter, a user equipment may transmit a measured parameter value report 220 to a RAN node. In an example embodiment, report 220 may comprise measured parameter values 511 and 512 corresponding to a first radio parameter indicated in field 510 and measured parameter values 516 and 517 corresponding a second radio parameter indicated in field 510. In another example embodiment, report 220 may comprise at least one count, number, or indication thereof, of at least one measured parameter value(s) that have been categorized into at least one particular quantization category during at least one corresponding validity period 411.

After expiration of a category-specific validity period that corresponds to a particular radio parameter, a user equipment may reset count information or volume information corresponding to the specific category that corresponds to the particular radio parameter. For example, if a validity period is configured via field 325 to be one hour, user equipment may be configured to monitor, determine, or measure, during the one hour period, at least one parameter value corresponding to at least one parameter and to categorize the measured/determined parameter value into at least one quantization category, associated with at least one range associated with the at least one parameter, that encompasses the at least one measured/determined parameter value. Thus, for a particular quantization category, the user equipment may determine whether a configured maximum allowed reporting volume/count, which may be configured via field 320, is reached during the configured validity period. In an example, a configured maximum volume/count may be reached after thirty minutes and during the remaining thirty minutes of the validity period corresponding to the quantization category, the user equipment may halt reporting of measured parameter values or counts categorized into the category. After the one-hour validity period expires, user equipment may reset a volume, or count, corresponding to measured parameter values, or counts thereof, indicated to or reported to a serving RAN node.

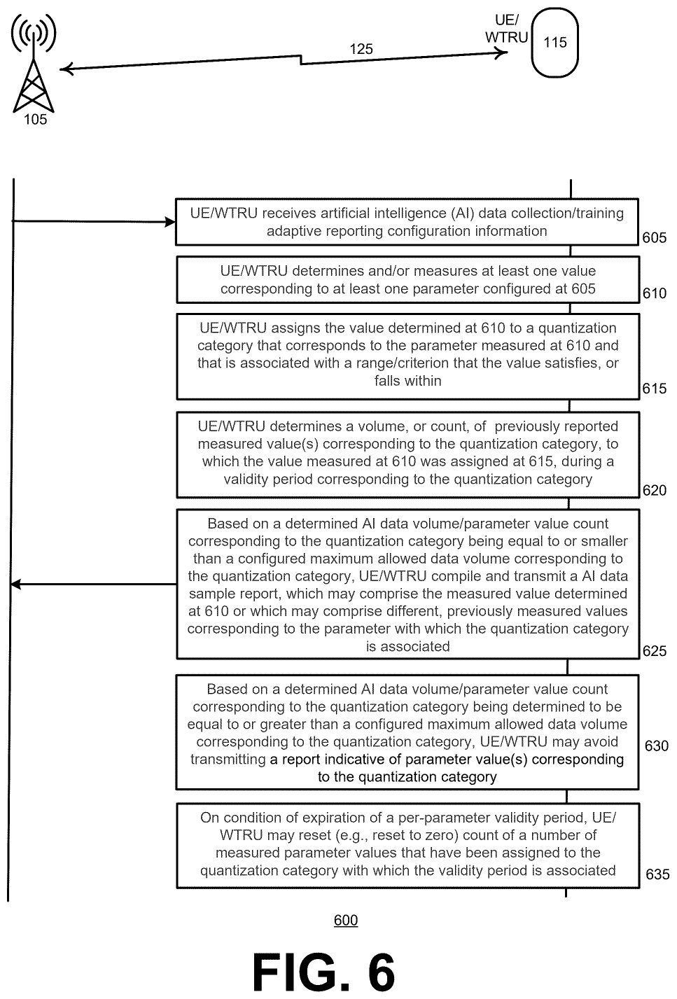

Turning now to FIG. 6, the figure illustrates a timing diagram of an example embodiment method 600 to facilitate user equipment 115 determining whether to report to RAN 105 one or more radio performance parameter values. At act 605, UE/WTRU 115 may receive artificial intelligence data collection/training adaptive reporting configuration information 210, which may be referred to as parameter reporting configuration information. Information 210 may comprise at least one indication of at least one parameter, with respect to which measured values may be used to trigger, or to avoid triggering, reporting of the measured values, or information corresponding thereto, to RAN node 105. Examples of parameters indicated in information 210 may comprise received signal power, received signal to interference, or other calculated radio parameters. Information 210 may comprise quantization information indicative of, or that defines, at least one quantization category corresponding to each of at least one parameter indicated by information 210. Information 210 may comprise at least one quantization category range criterion respectively corresponding to the at least one quantization category. Information 210 may comprise a maximum reported data volume, or count, (e.g., a reporting criterion) of measured parameter values corresponding to the at least one indicated parameter that is applicable to each of the at least one quantization category indicated by or defined by information 210. Information 210 may comprise at least one validity period with respect to which user equipment 115 is to measure parameter values and count a number of the measured parameter values that are categorized into at least one quantization category respectively corresponding to the at least one validity period.

At act 610, UE/WTRU 115 may measure, determine, or calculate, at least one parameter value corresponding to the at least one parameter indicated by information 210. The parameter value measured, determined or calculated at act 610 may be based on a measurement performed with respect to a signal, for example a reference signal, broadcast or transmitted by RAN node 105 via radio link(s) 125. At act 615, UE/WTRU may determine at least one quantization category based on the at least one measured parameter value satisfying, falling within, or otherwise corresponding to at least one range respectively associated with the at least one parameter in information 210. At act 620, UE/WTRU 115 may determine a current volume, or a count, of a number of measured parameter values, corresponding to a parameter, that have been assigned to, or categorized into, a particular quantization category, and that may have been reported by the UE to RAN node 105 during a configured validity period corresponding to the particular quantization category. Based on a determined count of measure parameter values that have been categorized into a particular quantization category being determined to be equal to or less than a maximum allowed data volume/parameter value count (e.g., being equal to or less than a quantization category reporting criterion indicated in field 320 shown in FIG. 3), configured via information 210 at act 605, corresponding to the particular quantization category, UE/WTRU 115 may transmit at act 625 a report, for example report 220 described in reference to FIG. 2, to RAN node 105. A report transmitted at act 625 may comprise measured parameter values corresponding to the parameter with which the particular quantization category is associated. The report transmitted at act 625 may comprise measured parameter values corresponding to other parameters, or corresponding to other quantization categories, which may be associated with other parameters, than the particular quantization category with respect to which the count of measured parameter values quantized thereinto is determined to be less than or equal to the quantization category reporting criterion. However, if the user equipment 115 determines that measured parameter value count corresponding to a particular quantization category is determined to be equal to or greater than a configured maximum allowed data volume corresponding to the particular quantization category, UE/WTRU 115 may avoid, at a configured or determine reporting time instant, transmitting a parameter report to RAN node 105 indicative of parameter value(s) corresponding to the particular quantization category. At act 635, based on UE/WTRU 115 having determined that a validity period corresponding to a particular quantization category has expired, the UE/WTRU may reset (e.g., set to zero) a counter value indicative of a count of a number of measured parameter values that have been assigned to, categorized into, or reported to RAN node 105, and that may correspond to the particular quantization category.

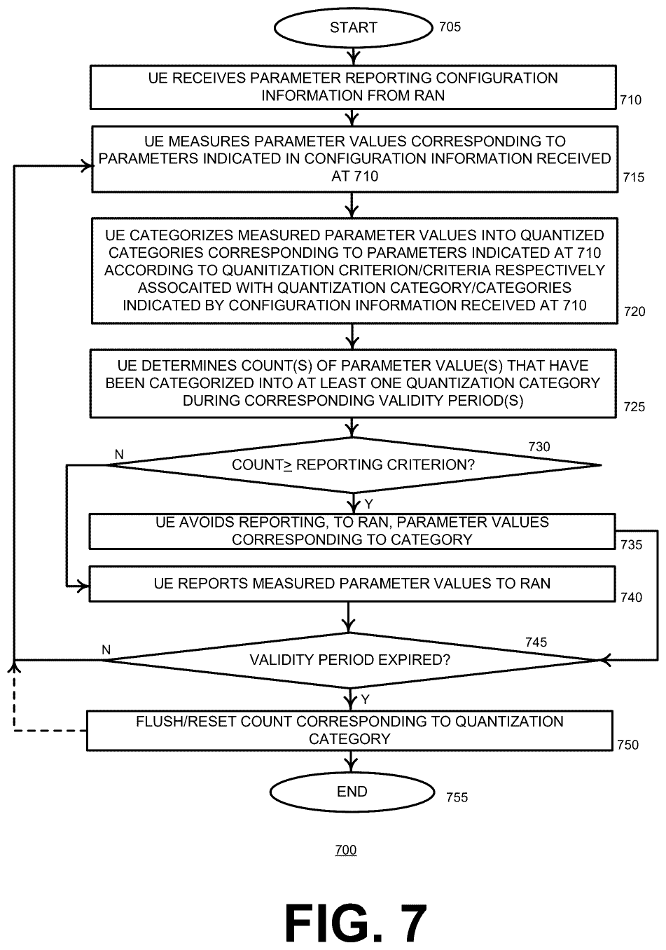

Turning now to FIG. 7, the figure illustrates a flow diagram of an example embodiment 700. Method 700 begins at act 705. At act 710, a user equipment may receive from a radio network node, network equipment, or a network element comprising, or corresponding to, a radio network node, parameter reporting configuration information, for example information 210 described in reference to FIG. 2. At act 715, the user equipment may measure parameter values corresponding to one or more parameters indicated in configuration information 210 received at act 710 with respect to a signal transmitted, or broadcast, by a radio network node that may be serving the user equipment. For example, the user equipment may measure or determine a signal strength value or a signal to interference noise ratio value at act 715. At act 720, the user equipment may categorize measured parameter values determined or measured at act 715 into quantization categories that correspond to parameters indicated in configuration information 210 received at act 710. The user equipment may determine a quantization category by determining a range criterion, configured via the configuration information received at act 210, that a measured parameter value satisfies, or falls within. For example, a first range criterion may be RSRP values less than −120 dBm, a second range criterion may be RSRP values −106 dBm to −120 dBm, a third range criterion may be RSRP values −90 dBm to −105 dBm, and a fourth range criterion may be RSRP values greater than −90 dBm. The first, second, third, and fourth ranges may be respectively associated, in configuration information 210 received at act 710, with first, second, third, and fourth quantization categories. In an example, signal strength values that may be categorized into the first quantization category may be characterized as ‘poor,’ signal strength values that may be categorized into the second quantization category may be characterized as ‘fair,’ signal strength values that may be categorized into the third quantization category may be characterized as ‘good,’ and signal strength values that may be categorized into the fourth quantization category may be characterized as ‘excellent.’ Accordingly, if the user equipment determines a measured signal strength parameter value (e.g., an RSRP value) of −100 dBm, the user equipment may categorize the measured signal strength parameter value into the third, or ‘good’, quantization category.

At act 725, the user equipment may determine a count, or a number, of measured parameter values that may have been categorized into one or more particular quantization categories and reported to the serving RAN node. For example, in the example of the user equipment measuring a signal strength parameter value of −100 dBm and categorizing the measured signal strength parameter value into the third quantization category, the user equipment may determine at act 725 how many measured signal strength parameter values have been categorized into the third quantization category and reported to the serving RAN node during a validity period corresponding to the third quantization category. Validity periods corresponding to the quantization categories may be indicated in the configuration information received at act 710. In an embodiment, a count determined at act 725 may be based on how many measured parameter values have been categorized into a particular quantization category during a validity period corresponding to the particular quantization category. In an embodiment, a count determined at act 725 may be based on how many measured parameter values categorized into a particular quantization category have been reported to the serving RAN node during a validity period corresponding to the particular quantization category.

At act 730, the user equipment may analyze a count corresponding to a particular quantization category with respect to a reporting criterion, which may comprise a reporting halting criterion, that may be configured via the configuration information received at act 710. For example, if a reporting criterion corresponding to the third quantization category is fifty, and the signal strength parameter value of −100 dBm measured at act 720 and categorized into the third quantization category at act 725 is determined at act 730 to be the fifty-first measured parameter value categorized into the third quantization category during a validity period corresponding to the third quantization category, the user equipment may determine that a reporting halting criterion is satisfied and method 700 may advance to act 735. At act 735, the user equipment may, at a configured, or determined, reporting instant that follows the determination made at act 730, avoid reporting to the serving RAN node measured parameter values corresponding to the third quantization category that may correspond to RSRP parameter values. Thus, the user equipment may avoid, during a remaining portion of a validity period corresponding to the third RSRP quantization category, using uplink radio resources to transmit a report indicative of additional measured signal strength values that correspond to a ‘good’ signal strength and thus avoid an artificial intelligence learning model being trained or updated at the serving RAN node by measured parameter values received from the user equipment being weighted, skewed, or biased heavily in favor of ‘good’ signal strength values. An updated version of the learning model, updated based on such weighting, skewing, or biasing of the artificial intelligence learning model by an overabundance of ‘good’ measured RSRP values may result in erroneous, undesirable, or suboptimal radio operation of network equipment corresponding to the RAN node and/or the user equipment if the updated version of the learning model is received by and deployed by the user equipment.

At act 745, the user equipment may determine whether a validity period corresponding to a quantization category with respect to which a reporting operation was performed at act 735 has expired. If a determination is made at act 745 that the validity period corresponding to a quantization category has not expired, method 700 may return to act 715 and the user equipment may continue to measure parameter values corresponding to parameters indicated by configuration information received at act 710. If a determination is made at act 745 that a validity period corresponding to a quantization category has expired, the user equipment may flush, or reset, a count value, which may be stored in a register, a buffer, or other memory of the user equipment, corresponding to the quantization category. After resetting a count value, or counter, at act 745, method 700 may end at act 755, or if the user equipment is configured to continue to measure parameter values and categorize the measured parameter values into quantization categories method 700 may return to act 715.

Returning to description of act 730, if the user equipment determines that a count of measured parameter values, corresponding to a particular quantization category, that may have been categorized into the particular quantization category and reported to the serving RAN node, is not equal to or greater than a reporting criterion corresponding to the quantization category, method 700 may advance to act 740. At act 740, at a time that may coincide with a reporting instant that is configured or that has been determined by the user equipment, the user equipment may transmit to the serving RAN node a report comprising one or more measured parameter value(s) that may have been categorized into the quantization category at act 720. A report transmitted at act 740 may comprise other measured parameter values corresponding to the quantization category, or the report transmitted at act 740 may comprise other measured parameter values corresponding to quantization categories other than the quantization category with respect to which the measured parameter value that was categorized at act 720 corresponds. Thus, starving an artificial intelligence learning model at the serving RAN node being trained or updated with measured parameter values reported by the user equipment of useful information may be avoided while biasing the learning model with an overabundance of information that is similar (e.g., an overabundance of measured parameter values corresponding to a particular quantization category) may also be avoided. After transmitting a report to the serving RAN node at act 740, the user equipment may determine whether a validity period corresponding to the quantization category with respect to which a measured parameter value was quantized at act 720 has expired. If a determination is made at act 740 that the validity period has not expired, method 700 may return to act 715. If a determination is made at act 745 that a validity period corresponding to the quantization category has expired, method 700 may advance to act 750. At act 750, the user equipment may flush, or reset, a count corresponding to the particular quantization category with respect to which a measured parameter value was quantized at act 720 and method 700 may end at 755 or return to act 715.

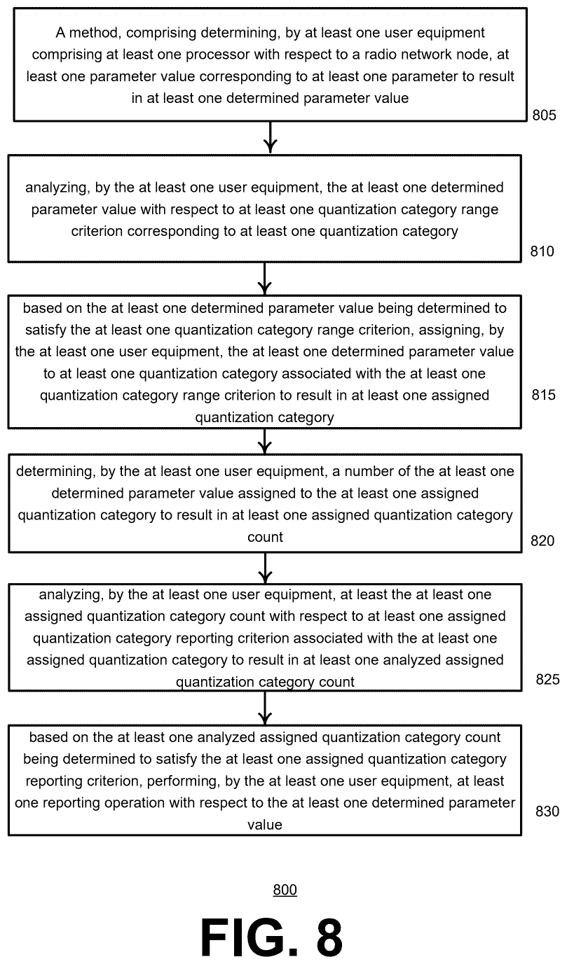

Turning now to FIG. 8, the figure illustrates an example embodiment method 800 comprising at block 805 determining, by at least one user equipment comprising at least one processor with respect to a radio network node, at least one parameter value corresponding to at least one parameter to result in at least one determined parameter value; at block 810 analyzing, by the at least one user equipment, the at least one determined parameter value with respect to at least one quantization category range criterion corresponding to at least one quantization category; at block 815 based on the at least one determined parameter value being determined to satisfy the at least one quantization category range criterion, assigning, by the at least one user equipment, the at least one determined parameter value to at least one quantization category associated with the at least one quantization category range criterion to result in at least one assigned quantization category; at block 820 determining, by the at least one user equipment, a number of the at least one determined parameter value assigned to the at least one assigned quantization category to result in at least one assigned quantization category count; at block 825 analyzing, by the at least one user equipment, at least the at least one assigned quantization category count with respect to at least one assigned quantization category reporting criterion associated with the at least one assigned quantization category to result in at least one analyzed assigned quantization category count; and at block 830 based on the at least one analyzed assigned quantization category count being determined to satisfy the at least one assigned quantization category reporting criterion, performing, by the at least one user equipment, at least one reporting operation with respect to the at least one determined parameter value.

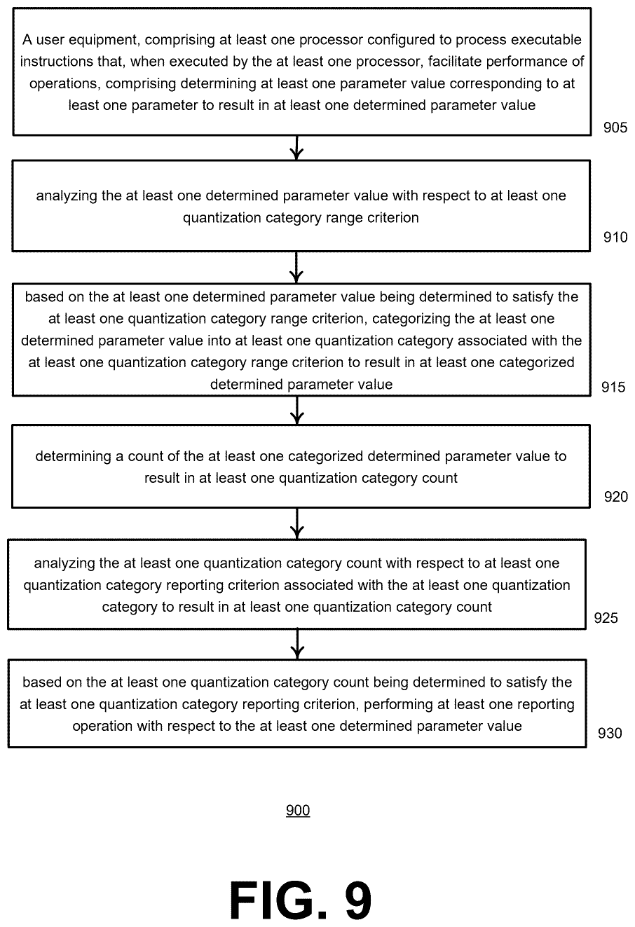

Turning now to FIG. 9, the figure illustrates a user equipment 900, comprising at block 905 at least one processor configured to process executable instructions that, when executed by the at least one processor, facilitate performance of operations, comprising determining at least one parameter value corresponding to at least one parameter to result in at least one determined parameter value; at block 910 analyzing the at least one determined parameter value with respect to at least one quantization category range criterion; at block 915 based on the at least one determined parameter value being determined to satisfy the at least one quantization category range criterion, categorizing the at least one determined parameter value into at least one quantization category associated with the at least one quantization category range criterion to result in at least one categorized determined parameter value; at block 920 determining a count of the at least one categorized determined parameter value to result in at least one quantization category count; at block 925 analyzing the at least one quantization category count with respect to at least one quantization category reporting criterion associated with the at least one quantization category to result in at least one quantization category count; and at block 930 based on the at least one quantization category count being determined to satisfy the at least one quantization category reporting criterion, performing at least one reporting operation with respect to the at least one determined parameter value.

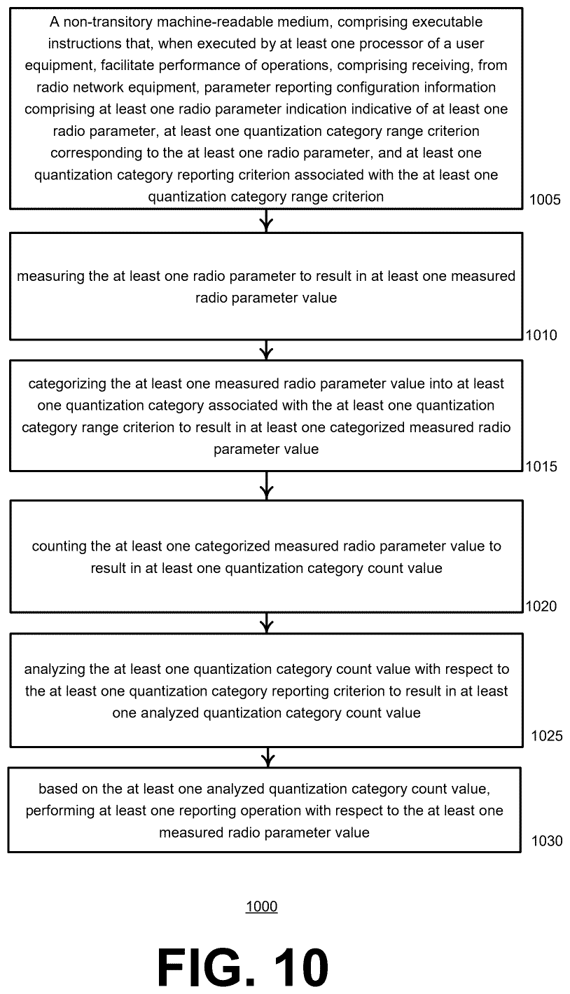

Turning now to FIG. 10, the figure illustrates a non-transitory machine-readable medium 1000 comprising at block 1005 executable instructions that, when executed by at least one processor of a user equipment, facilitate performance of operations, comprising, receiving, from radio network equipment, parameter reporting configuration information comprising at least one radio parameter indication indicative of at least one radio parameter, at least one quantization category range criterion corresponding to the at least one radio parameter, and at least one quantization category reporting criterion associated with the at least one quantization category range criterion; at block 1010 measuring the at least one radio parameter to result in at least one measured radio parameter value; at block 1015 categorizing the at least one measured radio parameter value into at least one quantization category associated with the at least one quantization category range criterion to result in at least one categorized measured radio parameter value; at block 1020 counting the at least one categorized measured radio parameter value to result in at least one quantization category count value; at block 1025 analyzing the at least one quantization category count value with respect to the at least one quantization category reporting criterion to result in at least one analyzed quantization category count value; and at block 1030 based on the at least one analyzed quantization category count value, performing at least one reporting operation with respect to the at least one measured radio parameter value.

In order to provide additional context for various embodiments described herein, FIG. 11 and the following discussion are intended to provide a brief, general description of a suitable computing environment 1100 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors and may include a cache memory. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

Computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can comprise a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

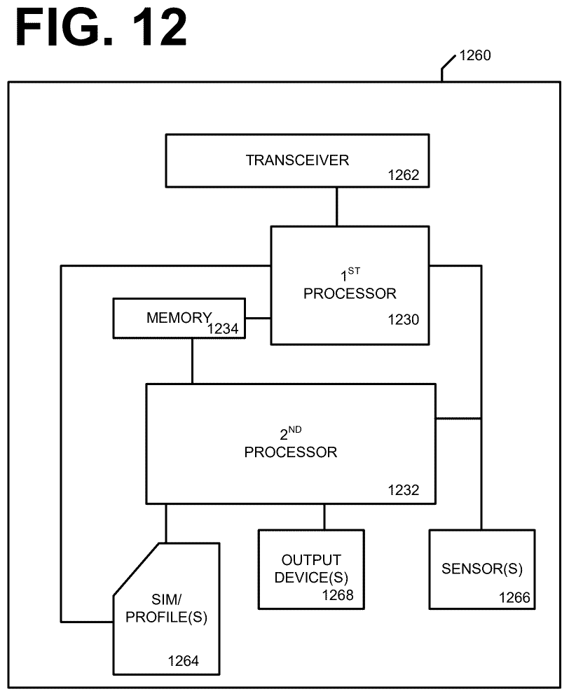

Turning now to FIG. 12, the figure illustrates a block diagram of an example UE 1260. UE 1260 may comprise a smart phone, a wireless tablet, a laptop computer with wireless capability, a wearable device, a machine device that may facilitate vehicle telematics, and the like. UE 1260 comprises a first processor 1230, a second processor 1232, and a shared memory 1234. UE 1260 includes radio front end circuitry 1262, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1262 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 12, UE 1260 may also include a SIM 1264, or a SIM profile, which may comprise information stored in a memory (memory 1234 or a separate memory portion), for facilitating wireless communication with RAN 105 or core network 130 shown in FIG. 1. FIG. 12 shows SIM 1264 as a single component in the shape of a conventional SIM card, but it will be appreciated that SIM 1264 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1264 and another device, which may be a component of RAN 105 or core network 130 shown in FIG. 1). A SIM profile 1264 may also comprise identifying information that is unique to the SIM, or SIM profile, such as, for example, an International Mobile Subscriber Identity (“IMSI”) or information that may make up an IMSI.

SIM 1264 is shown coupled to both the first processor portion 1230 and the second processor portion 1232. Such an implementation may provide an advantage that first processor portion 1230 may not need to request or receive information or data from SIM 1264 that second processor 1232 may request, thus eliminating the use of the first processor acting as a ‘go-between’ when the second processor uses information from the SIM in performing its functions and in executing applications. First processor 1230, which may be a modem processor or baseband processor, is shown smaller than processor 1232, which may be a more sophisticated application processor, to visually indicate the relative levels of sophistication (i.e., processing capability and performance) and corresponding relative levels of operating power consumption levels between the two processor portions. Keeping the second processor portion 1232 asleep/inactive/in a low power state when UE 1260 does not need it for executing applications and processing data related to an application provides an advantage of reducing power consumption when the UE only needs to use the first processor portion 1230 while in listening mode for monitoring routine configured bearer management and mobility management/maintenance procedures, or for monitoring search spaces that the UE has been configured to monitor while the second processor portion remains inactive/asleep.

UE 1260 may also include sensors 1266, such as, for example, temperature sensors, accelerometers, gyroscopes, barometers, moisture sensors, and the like that may provide signals to the first processor 1230 or second processor 1232. Output devices 1268 may comprise, for example, one or more visual displays (e.g., computer monitors, VR appliances, and the like), acoustic transducers, such as speakers or microphones, vibration components, and the like. Output devices 1268 may comprise software that interfaces with output devices, for example, visual displays, speakers, microphones, touch sensation devices, smell or taste devices, and the like, that are external to UE 1260.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by at least one user equipment comprising at least one processor with respect to a radio network node, at least one parameter value corresponding to at least one parameter to result in at least one determined parameter value;
analyzing, by the at least one user equipment, the at least one determined parameter value with respect to at least one quantization category range criterion corresponding to at least one quantization category;
based on the at least one determined parameter value being determined to satisfy the at least one quantization category range criterion, assigning, by the at least one user equipment, the at least one determined parameter value to at least one quantization category associated with the at least one quantization category range criterion to result in at least one assigned quantization category;
determining, by the at least one user equipment, a number of the at least one determined parameter value assigned to the at least one assigned quantization category to result in at least one assigned quantization category count;
analyzing, by the at least one user equipment, at least the at least one assigned quantization category count with respect to at least one assigned quantization category reporting criterion associated with the at least one assigned quantization category to result in at least one analyzed assigned quantization category count; and
based on the at least one analyzed assigned quantization category count being determined to satisfy the at least one assigned quantization category reporting criterion, performing, by the at least one user equipment, at least one reporting operation with respect to the at least one determined parameter value.

2. The method of claim 1, further comprising:
determining, by the at least one user equipment, that a configured quantization period has expired; and
in response to the determining that the configured quantization period has expired, resetting, by the at least one user equipment, the at least one assigned quantization category count.

3. The method of claim 1, wherein the at least one assigned quantization category reporting criterion comprises at least one report halting criterion.

4. The method of claim 3, wherein the at least one assigned quantization category reporting criterion is determined to be satisfied by the at least one assigned quantization category count being determined to satisfy a function with respect to a threshold count defined by the at least one report halting criterion.

5. The method of claim 4, wherein the at least one reporting operation comprises avoiding reporting the at least one determined parameter value to the radio network node.

6. The method of claim 5, wherein the at least one determined parameter value is at least one first determined parameter value, and wherein the method further comprises:
determining, by the at least one user equipment, at least one second parameter value corresponding to the at least one parameter to result in at least one second determined parameter value;
analyzing, by the at least one user equipment, the at least one second determined parameter value with respect to the at least one quantization category range criterion;
based on the at least one second determined parameter value being determined to satisfy the at least one quantization category range criterion, assigning, by the at least one user equipment, the at least one second determined parameter value to the at least one assigned quantization category; and
based on expiration of at least one assignment quantization category validity period corresponding to the at least one assigned quantization category, reporting, by the at least one user equipment, at least the at least one second determined parameter value to the radio network node.

7. The method of claim 1, wherein the at least one parameter comprises at least one of: a received signal signal strength corresponding to a signal corresponding to the radio network node or a received signal signal strength to interference ratio corresponding to the signal corresponding to the radio network node.

8. The method of claim 1, wherein the at least one parameter value is a first parameter value, wherein the at least one determined parameter value is a first determined parameter value, wherein the at least one quantization category is a first quantization category, wherein the number of the at least one determined parameter value assigned to the at least one assigned quantization category is a first number, wherein the at least one quantization category range criterion is at least one first quantization category range criterion, wherein the at least one assigned quantization category is at least one first assigned quantization category, wherein the at least one assigned quantization category count is at least one first assigned quantization category count, wherein the at least one analyzed assigned quantization category count is at least one first analyzed assigned quantization category count, wherein the at least one reporting operation is at least one first reporting operation, wherein the at least one assigned quantization category reporting criterion is at least one first assigned quantization category reporting criterion, and wherein the method further comprises:
determining, by the at least one user equipment, at least one second parameter value corresponding to the at least one parameter to result in at least one second determined parameter value;
analyzing, by the at least one user equipment, the at least one second determined parameter value with respect to a second quantization category range criterion corresponding to a second quantization category associated with the at least one parameter;
based on the at least one second determined parameter value being determined to satisfy the second quantization category range criterion, assigning, by the at least one user equipment, the at least one second determined parameter value to the second quantization category to result in a second assigned quantization category;
determining, by the at least one user equipment, a second number of the at least one second determined parameter value assigned to the second quantization category to result in a second assigned quantization category count;
analyzing, by the at least one user equipment, the second assigned quantization category count with respect to a second assigned quantization category reporting criterion associated with the second quantization category to result in a second analyzed assigned quantization category count; and
based on the second analyzed assigned quantization category count being determined to fail to satisfy the second assigned quantization category reporting criterion, performing, by the at least one user equipment, a second reporting operation with respect to the at least one second determined parameter value.

9. The method of claim 8, wherein the second analyzed assigned quantization category count being determined to fail to satisfy the second assigned quantization category reporting criterion comprises the second analyzed assigned quantization category count being determined to be equal to or to be less than the second assigned quantization category reporting criterion, and wherein the second reporting operation comprises reporting, by the at least one user equipment to the radio network node, the at least one second determined parameter value.

10. The method of claim 1, wherein the at least one parameter is at least one first parameter, wherein the at least one parameter value is at least one first parameter value, wherein the at least one determined parameter value is at least one first determined parameter value, wherein the at least one quantization category is at least one first quantization category, wherein the number of the at least one determined parameter value assigned to the at least one assigned quantization category is a first number, wherein the at least one quantization category range criterion is at least one first quantization category range criterion, wherein the at least one assigned quantization category is at least one first assigned quantization category, wherein the at least one assigned quantization category count is at least one first assigned quantization category count, wherein the at least one analyzed assigned quantization category count is at least one first analyzed assigned quantization category count, wherein the at least one reporting operation is at least one first reporting operation, wherein the at least one first reporting operation comprises avoiding, by the at least one user equipment, reporting the at least one first determined parameter value to the radio network node, wherein the at least one assigned quantization category reporting criterion is at least one first assigned quantization category reporting criterion, and wherein the method further comprises:
determining, by the at least one user equipment, at least one second parameter value corresponding to at least one second parameter to result in at least one second determined parameter value, wherein the at least one first parameter and the at least one second parameter are different;
analyzing, by the at least one user equipment, the at least one second determined parameter value with respect to a second quantization category range criterion corresponding to at least one second quantization category associated with the second parameter;
based on the at least one second determined parameter value being determined to satisfy the at least one second quantization category range criterion, assigning, by the at least one user equipment, the at least one second determined parameter value to the at least one second quantization category to result in at least one second assigned quantization category;
determining, by the at least one user equipment, a second number of the at least one second determined parameter value assigned to the at least one second quantization category to result in at least one second assigned quantization category count;
analyzing, by the at least one user equipment, the at least one second assigned quantization category count with respect to at least one second assigned quantization category reporting criterion associated with the at least one second quantization category to result in at least one second analyzed assigned quantization category count; and
based on the at least one second analyzed assigned quantization category count being determined to fail to satisfy the at least one second assigned quantization category reporting criterion, performing, by the at least one user equipment, at least one second reporting operation with respect to the at least one second determined parameter value.

11. The method of claim 10, wherein the at least one second analyzed assigned quantization category count being determined to fail to satisfy the at least one second assigned quantization category reporting criterion comprises the at least one second analyzed assigned quantization category count being determined to satisfy a function of a count defined by the at least one second assigned quantization category reporting criterion, and wherein the second reporting operation comprises reporting, by the at least one user equipment to the radio network node, the at least one second determined parameter value.

12. The method of claim 1, further comprising:
receiving, by the at least one user equipment from the radio network node, parameter reporting configuration information comprising at least the at least one quantization category range criterion.

13. A user equipment, comprising at least one processor configured to process executable instructions that, when executed by the at least one processor, facilitate performance of operations, comprising:
determining at least one parameter value corresponding to at least one parameter to result in at least one determined parameter value;
analyzing the at least one determined parameter value with respect to at least one quantization category range criterion;
based on the at least one determined parameter value being determined to satisfy the at least one quantization category range criterion, categorizing the at least one determined parameter value into at least one quantization category associated with the at least one quantization category range criterion to result in at least one categorized determined parameter value;
determining a count of the at least one categorized determined parameter value to result in at least one quantization category count;
analyzing the at least one quantization category count with respect to at least one quantization category reporting criterion associated with the at least one quantization category to result in at least one quantization category count; and
based on the at least one quantization category count being determined to satisfy the at least one quantization category reporting criterion, performing at least one reporting operation with respect to the at least one determined parameter value.

14. The user equipment of claim 13, wherein the at least one quantization category reporting criterion comprises at least one report halting criterion.

15. The user equipment of claim 14, wherein the at least one quantization category reporting criterion is determined to be satisfied by the at least one quantization category count being determined to equal or to exceed a value defined in accordance with the at least one report halting criterion.

16. The user equipment of claim 15, wherein the at least one reporting operation comprises avoiding reporting the at least one determined parameter value to a radio network node.

17. A non-transitory machine-readable medium, comprising executable instructions that, when executed by at least one processor of a user equipment, facilitate performance of operations, comprising:
receiving, from radio network equipment, parameter reporting configuration information comprising at least one radio parameter indication indicative of at least one radio parameter, at least one quantization category range criterion corresponding to the at least one radio parameter, and at least one quantization category reporting criterion associated with the at least one quantization category range criterion;
measuring the at least one radio parameter to result in at least one measured radio parameter value;
categorizing the at least one measured radio parameter value into at least one quantization category associated with the at least one quantization category range criterion to result in at least one categorized measured radio parameter value;
counting the at least one categorized measured radio parameter value to result in at least one quantization category count value;
analyzing the at least one quantization category count value with respect to the at least one quantization category reporting criterion to result in at least one analyzed quantization category count value; and
based on the at least one analyzed quantization category count value, performing at least one reporting operation with respect to the at least one measured radio parameter value.

18. The non-transitory machine-readable medium of claim 17, wherein the at least one quantization category reporting criterion comprises at least one report halting criterion, wherein the at least one quantization category reporting criterion is determined to be satisfied by the at least one analyzed quantization category count value being determined to equal or to exceed a value defined in accordance with the at least one report halting criterion, and wherein the at least one reporting operation comprises avoiding reporting the at least one measured radio parameter value to the radio network equipment.

19. The non-transitory machine-readable medium of claim 17, wherein the at least one quantization category reporting criterion comprises at least one report halting criterion, wherein the at least one analyzed quantization category count value is determined to fail to satisfy the at least one quantization category reporting criterion based on the at least one analyzed quantization category count value being determined to equal or to be less than a value defined in accordance with the at least one report halting criterion, and wherein the at least one reporting operation comprises reporting the at least one measured radio parameter value to the radio network equipment.

20. The non-transitory machine-readable medium of claim 17, wherein the parameter reporting configuration information further comprises at least one quantization period indication indicative of at least one quantization period, wherein the at least one measured radio parameter value further results from measuring the at least one radio parameter during the at least one quantization period, and wherein the operations further comprise:
resetting the at least one quantization category count value after the at least one quantization period.
